(19) United States
(12) Patent Application Publication
(10) Pub. No.: US 2014/0258042 A1
(43) Pub. Date: Sep. 11, 2014

(54) System and Method for Facilitating Real Estate Transactions

(71) Applicants: Christopher Butler, San Francisco, CA (US); Thomas A. Horvath, San Francisco, CA (US)

(72) Inventors: Christopher Butler, San Francisco, CA (US); Thomas A. Horvath, San Francisco, CA (US)

(21) Appl. No.: 13/790,839

(22) Filed: Mar. 8, 2013

(51) Int. Cl. G06Q 30/06; G06Q 50/16

(52) U.S. Cl. CPC G06Q 30/0627; G06Q 50/16
USPC 705/26.63

(57) ABSTRACT

A system, method and software is described for the advertising of real estate. Information and images for a property are made available to prospective purchasers. Users' interactions are tracked, and points are assigned for each interaction. For each property listing, the system and software identify a segment of other relevant property listings. Each property listing is compared to the listings in its segment on the basis of points to determine its relative ranking. The relative ranking is used to determine the fee charged to the seller for use of the system and software. The system and software generate and provide reports and recommendations to users.

### BACKGROUND

The sale and rental of real estate is a complicated process. Sellers and lessors desire to maximize the purchase or lease value of their property, and buyers and renters desire to find a property with the most favorable characteristics at an attractive price. A seller typically enlists the services of a real estate agent, who has knowledge of the local real estate market, experience finding buyers, marketing expertise and access to a multiple listing service (“MLS”). An MLS is a service that facilitates the sale of properties by allowing real estate agents and brokers to list information about a seller's property and search for properties relevant to buyers they represent. There are currently somewhere between 800 and 2,000 local MLS databases in the United States. Without retaining a real estate agent, a seller cannot access an MLS to assist in the advertising and sale of the seller's property. Additionally, MLSs are localized services and only contain information regarding properties for sale in their specific region, which can encompass as little as one city.

Some websites provide the public with access to property information obtained from publicly available records. Some websites offer to advertise a property or real estate-related services and charge a flat rate, a monthly fee, or a fee for each referral. For example, a seller may purchase a “for sale by seller” listing for a flat rate, and the listing will appear on the website for a set period of time. The fees are unaffected by how much buyer interest is generated for the property. Additionally, neither of these solutions provide sellers, agents and brokers insight into, for example, (1) how to maximize interest in their listings, (2) how to maximize the market value of a listing (e.g., when is the best timing to list a property to maximize market value), or (3) how to minimize the time on market for the property.

In view of the foregoing, there is a need for a universally available platform to advertise properties for sale or lease that allows any buyer or renter to access all of the information necessary to help them understand the value of each property in the context of the marketplace. Moreover, there is a need for a platform to inform and guide sellers/lessors on how to best market their properties online. There is a need for a platform that provides a seller/lessor with significantly greater specificity about the current demand for their property at any point in time, how that demand affects the price, and where to focus their efforts in listing the details of the property in order to maximize interest. There is also a need to better align the incentives of an advertising service with the seller's/lessor's priorities, to optimize real estate advertising, and to more effectively target interested prospective buyers/renters.

### SUMMARY

In view of the foregoing disadvantages inherent in the art, and in accordance with a first preferred embodiment of the present invention, a real estate application is described. A seller provides information and images of a property to a server, which stores the information and images and makes them available to users of the system such as prospective buyers. The users' interactions with the real estate application are monitored and recorded, and points are assigned for each of the user's actions. The real estate application compares each property listing to other listings stored in the system to identify a relevant segment of properties. Each property listing is compared to the other properties in its segment on the basis of accumulated points to produce a ranking. The ranking for each property is then used to determine the fee to be charged to the seller for use of the real estate application. Market level statistics for each segment are reported to the seller when the property is listed and regularly thereafter to inform the seller about how the market is performing for comparable properties in the seller's relevant area.

### BRIEF DESCRIPTION OF THE DRAWINGS

The detailed description makes reference to the accompanying figures wherein:

FIG. 1 illustrates an exemplary network diagram.

FIG. 2A illustrates a flowchart depicting the preferred process for a property seller to use the disclosed real estate application.

FIG. 2B illustrates a flowchart depicting the preferred process for a prospective buyer to use the disclosed real estate application.

FIG. 3A illustrates an exemplary “Search Criteria” screen.

FIG. 3B illustrates an exemplary “Search Results” screen.

FIG. 3C illustrates an exemplary “Summary View” screen.

FIG. 3D illustrates an exemplary “Detailed View” screen.

FIG. 4 illustrates an exemplary table containing actions and interest point values.

FIG. 5 illustrates a flowchart depicting a process to determine a fee to be charged to a user of the real estate application.

FIG. 6 illustrates a table containing overall percentile ranks and monthly charges.

Other objects, features, and characteristics of the present invention, as well as methods of operation and functions of the related elements of the structure and software, and the combination of parts and algorithms, will become more apparent upon consideration of the following detailed description with reference to the accompanying drawings, all of which form part of this specification.

### DETAILED DESCRIPTION OF THE PREFERRED EMBODIMENT

A detailed illustrative embodiment of the present invention is disclosed herein. However, techniques, methods, processes, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

None of the terms used herein, including “computer”, “server”, “memory”, “database”, and “network” are meant to limit the application of the invention. Any reference to “seller” is exemplary and is intended to encompass sellers, lessors, landlords, and representatives and agents thereof, along with any similarly situated person in a position to convey full or partial rights to a property. Any reference to “buyer” is exemplary and is intended to encompass buyers, lessees, and representatives and agents thereof, along with any similarly situated person in a position to obtain full or partial rights to a property. Any reference to “sale” or “purchase” is exemplary and is intended to encompass sales, leases and other transfers of property rights. The terms are used to illustrate the preferred embodiment and are not intended to limit the scope of the invention. Similarly, the use of these terms is not meant to limit the scope or application of the invention, as the invention is versatile and can be utilized in many applications, as will be apparent. The following presents a detailed description of the preferred embodiment of the present invention with reference to the figures.

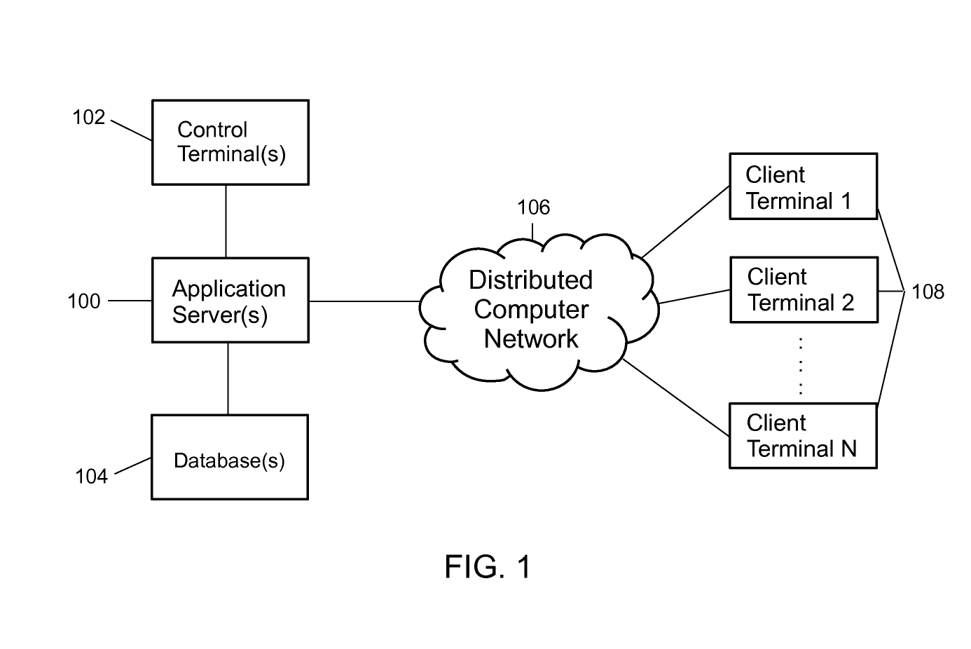

Referring to FIG. 1, shown is an exemplary network diagram featuring primary components for enabling the disclosed real estate application. In the preferred embodiment, a real estate application is stored and operated in a computer server and accessed by one or more local or remote computers. Server 100 is communicatively coupled to control terminal 102 and database 104. In a preferred embodiment, control terminal 104 comprises a conventional computer comprising a CPU, keyboard, monitor, mouse and modem. Database 104 preferably comprises conventional random access memory. Server 100 is also coupled to client terminals 108 via distributed computer network 106, which may comprise the Internet, a local area network, a wide area network, a wireless network, another communications network, or any combination thereof. Client terminals 108 are used to connect to server 100 by property sellers, prospective buyers, real estate agents, lenders, appraisers, and others.

Server 100 preferably provides data and services to users at client terminals 108 via website pages or dedicated, proprietary software. In alternative embodiments, the communications between server 100 and users of the system may be accomplished via mobile device application, instant messaging service, telephone, electronic mail, facsimile communications, mail, etc.

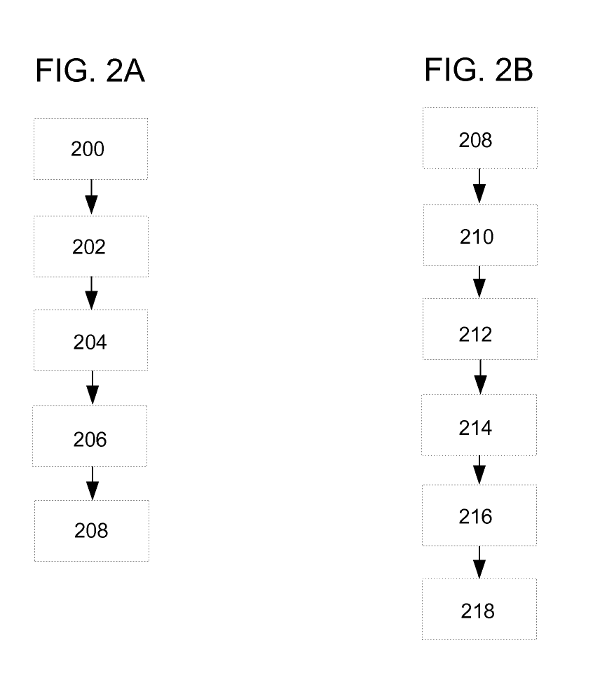

Referring to FIG. 2A, shown is a flowchart depicting the preferred process for a property seller to use the real estate application hosted in server 100. In step 200, the seller logs into the server. The login may be accomplished by entering a username and password or any other form(s) of identification. Alternatively, the real estate application may permit users to use the application anonymously without logging in. In step 202, the seller enters information about a residential property for sale. Preferably, the seller first identifies the type of residential structure, which may be a single family residence, condominium, townhome, multi-unit residence, mobile home, or land zoned for residential use. Additional information entered by the seller preferably includes one or more of the property address, space size, lot size, number of bedrooms, number of bathrooms, the asking price, the lease term (if applicable) and any other information relevant to the sale of the property. In step 204, the seller preferably identifies the quality of one or more of the previously-identified property attributes. Quality may be measured by the age and condition of the property attribute. For example, a seller may indicate that the kitchen contains granite countertops which are in very good condition, or the seller may indicate that an in-ground pool was installed within the past year. In step 206, the seller may optionally upload images of the property, the surrounding area, aerial views, or other images relevant to the property. The images may be labeled by the seller as well. It should be appreciated that, in some embodiments, the foregoing steps may be reordered, so that the seller uploads images before entering information about the property. Similarly, the real estate application may be configured to permit the seller to enter information and upload images without a login, after which the application may require the user to log in before the listing will be made available to prospective buyers. The real estate application may also be configured to require that the seller create a user account and log in before entering information and uploading images. In step 208, the seller indicates to the real estate application that the property listing is complete. The real estate application then posts the property listing and makes it available to be searched and viewed by prospective buyers and other users of the system.

The foregoing embodiment described with reference to FIG. 2A depicts a process for a property seller listing a residential property for sale, but may also be applied to residential properties for lease, commercial or industrial properties for sale, or commercial or industrial properties for lease. In such an embodiment, the seller preferably identifies the nature of the property, such as, for example, office space, industrial space, retail space, or land zoned for a particular purpose, along with additional relevant information about the property.

In an alternative embodiment, the server may obtain some or all information about the property via third party sources and/or publicly available records. The user may, for example, provide login credentials to the server and authorize the server to access otherwise-restricted information from third party sources. The server may also confirm user-provided information by consulting third party and/or publicly available records, and such confirmation may be indicated in the property listing.

Referring to FIG. 2B, shown is a flowchart depicting the preferred process for a prospective buyer to use the real estate application hosted in server 100. In step 210, the buyer logs in to the server. The login may be accomplished in the same form as discussed with respect to the seller in FIG. 2A. Once the buyer has access to the application, the buyer performs a search of available property listings in step 212. The buyer may enter and prioritize the buyer's preferred criteria for the search, as will be described. In step 214, the buyer views a list of search results that match one or more of the buyer's criteria. In step 216, the buyer identifies one or more properties for which the buyer would like more information. In step 218, the buyer views additional information and images, if available, for each property selected in the previous step. In step 220, the buyer may elect to take further action with respect to a property. For example, the buyer may choose to contact the seller to schedule a viewing, ask a question or submit an offer to purchase the property.

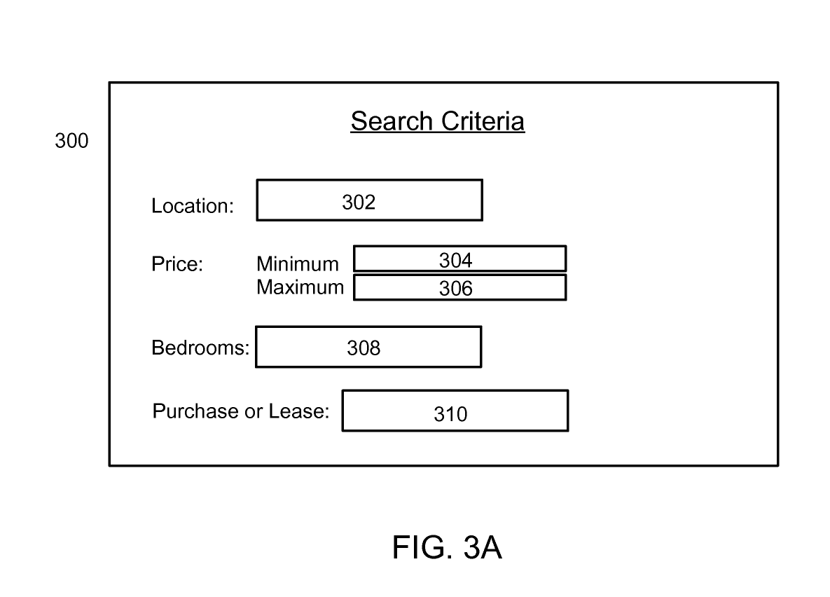

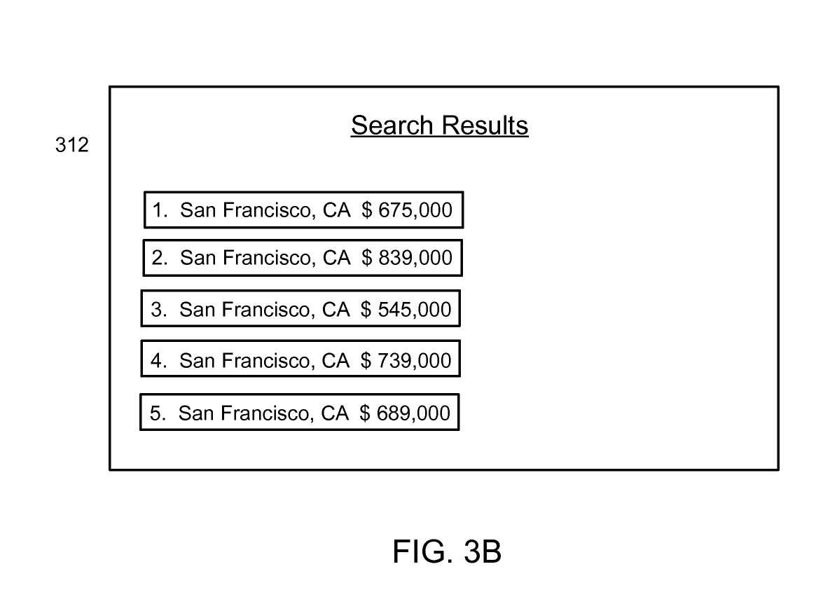

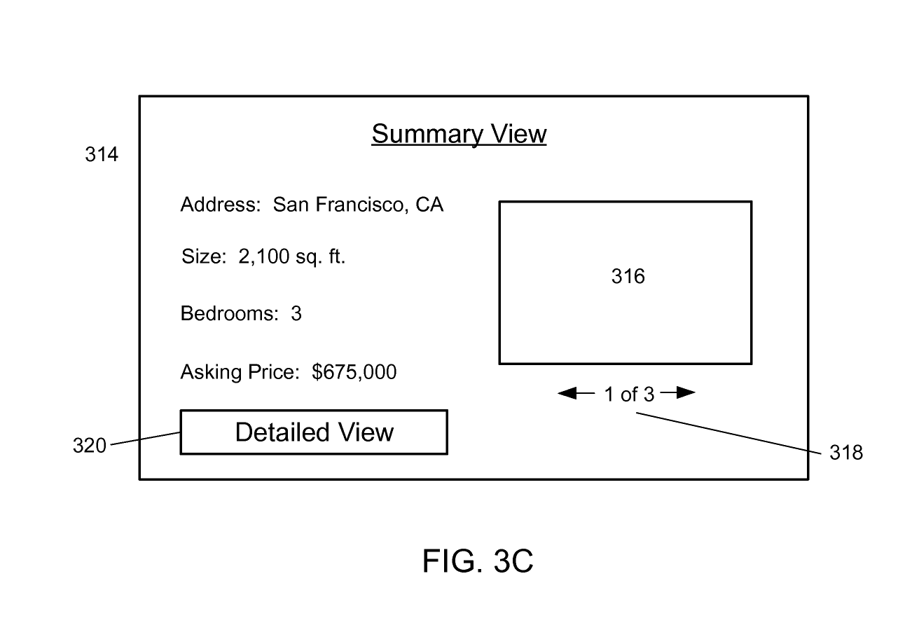

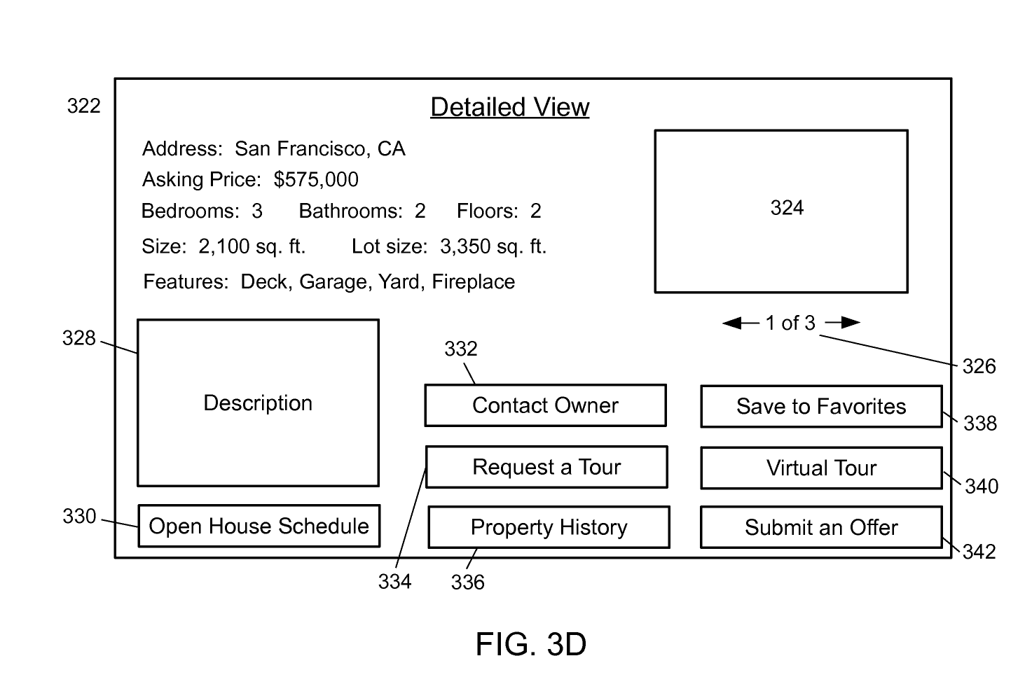

FIG. 3A depicts an exemplary “Search Criteria” screen 300 displayed to a user by the real estate application. Using this screen, the user may enter, select or otherwise identify the user's preferred criteria for a property. In the preferred embodiment, the user may search for properties according to location, price range, number of bedrooms and a purchase or lease basis. Specifically, the user may enter, select or otherwise identify the user's location preference in field 302, the user's minimum price in field 304, the user's maximum price in field 306, the user's preferred number of bedrooms in field 308 and the user's preference to purchase or lease in field 310. Once the user has entered the desired information, the search request is submitted. The user's search request is then received and processed by the server 100 and database 104, shown in FIG. 1.

FIG. 3B depicts an exemplary “Search Results” screen 312 displayed to the user in response to the user's search request. The properties with the highest relevance to the user's search criteria are displayed. The user may select a property to view additional information and images for that property. If the user selects a property, the real estate application provides a “Summary View” screen for the chosen property.

FIG. 3C depicts an exemplary “Summary View” screen 314 with information and images for a specific property. In the preferred embodiment disclosed in FIG. 3C, “Summary View” screen 314 includes information about the address of the property, the size of the property, the number of bedrooms, and the asking price. Image field 316 may be used to view images of or relevant to the property. Controls 318 enable the user to scroll through additional images of or relevant to the property. The user may select field 320 to view a “Detailed View” screen for the chosen property.

FIG. 3D depicts an exemplary “Detailed View” screen 322 with information and images for a specific property. In the preferred embodiment disclosed in FIG. 3D, “Detailed View” screen 322 includes information about the address of the property, the asking price, the number of bedrooms, the number of bathrooms, the number of floors, the size of the property, the size of the lot, and any features of the property. Image field 324 may be used to view images of or relevant to the property. Controls 326 enable the user to scroll through additional images of or relevant to the property. Description field 328 contains a narrative description of the property. Field 330 allows a user to view the open house schedule for the property. Field 332 allows a user to contact the seller of the property. Communication may be made by e-mail, instant message, video chat, or other suitable means of communication. Field 334 allows a user to request a tour of the property. Field 336 allows a user to view the history of the property, including, for example, the year the building was constructed. Field 338 allows a user to save a link to the property listing in a “Favorites” file associated with the user's account. Preferably, the “Favorites” file is stored in memory accessible to the real estate application and allows the user to easily return to the “Summary View” or “Detailed View” screen for the chosen property. Field 340 allows the user to view a virtual tour of the property, including interactive images, video and audio. Field 342 allows the user to submit an offer to purchase or lease the property. It should be understood that additional information and functionality may be made available to the user via the “Detailed View” screen.

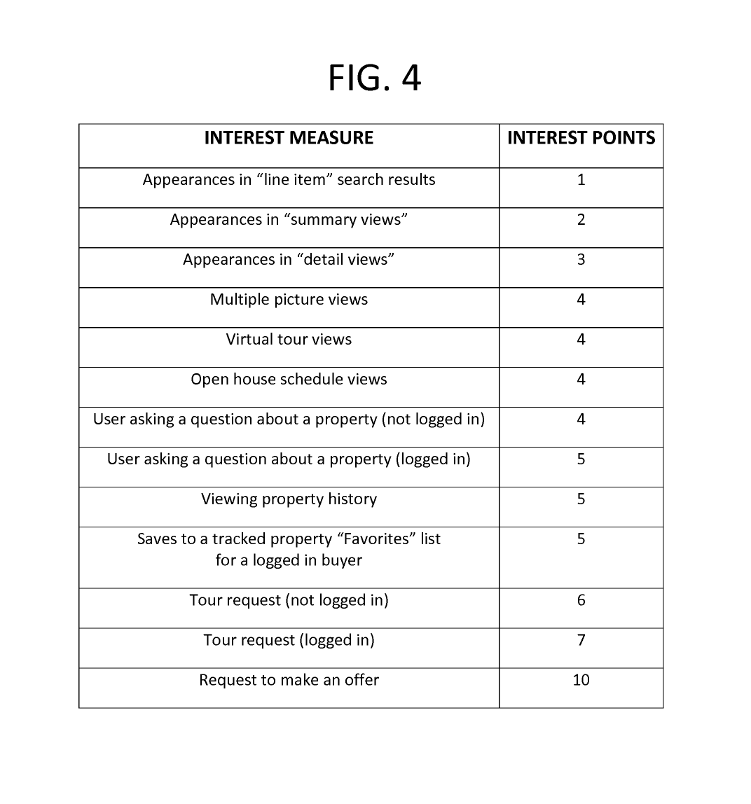

The real estate application tracks and records the actions of users, and particular actions are assigned interest points according to a predetermined table. Referring to FIG. 4, shown is an exemplary table depicting actions and their assigned interest point values. Interest points are continuously recorded for every listing stored in the database, and a running total of interest points is maintained for each property. For example, once a user has performed a search, the real estate application returns a list of relevant properties, as previously described. If a particular property appears on the search results screen (an example of which is depicted in FIG. 3B), the listing is assigned 1 interest point. Thus, every time a property appears in a search results screen, the total number of interest points for that listing is increased by 1. As shown in FIG. 4, a listing is assigned 2 points every time the property is shown to a user in a “Summary View” screen, an example of which is depicted in FIG. 3C. A listing is assigned 3 points every time the property is shown to a user in a “Detailed View” screen, an example of which is depicted in FIG. 3D. A listing is assigned 4 points when a user views multiple images on the property's “Detailed View” screen, when the user chooses to view a virtual tour of the property, when the user views the open house schedule for the property, and when a user that has not logged in asks a question about the property. When a user that has logged in asks a question about a property, the listing is assigned 5 points. A listing is also assigned 5 points when a user views the history of the property or when a user that is logged in saves the property to a tracked property list, or “Favorites” list. A request to tour the property results in 6 points if the user is not logged in and 7 points if the user is logged in. A listing is assigned 10 points if a user requests to make an offer to purchase the property.

Preferably, the real estate application tracks and records additional events relevant to the property, and may optionally assign interest points to each action. Exemplary events include a prospective buyer calling the seller, a prospective buyer scheduling a visit to the property, an interested party providing feedback relevant to the property, a property status update, and a change to the asking price. An open house may be tracked and recorded, and may be measured by the number of visitors to the property during the open house. The real estate application may also track the physical location of a user viewing a listing, the physical location of a user that schedules a visit to the property, the physical location of a user scheduled to attend an open house, the number of return visits to a listing page or a property, and the number of return visits to a listing page or a property prior to an offer being made. Preferably, the real estate application also records the date and time of each user action and event.

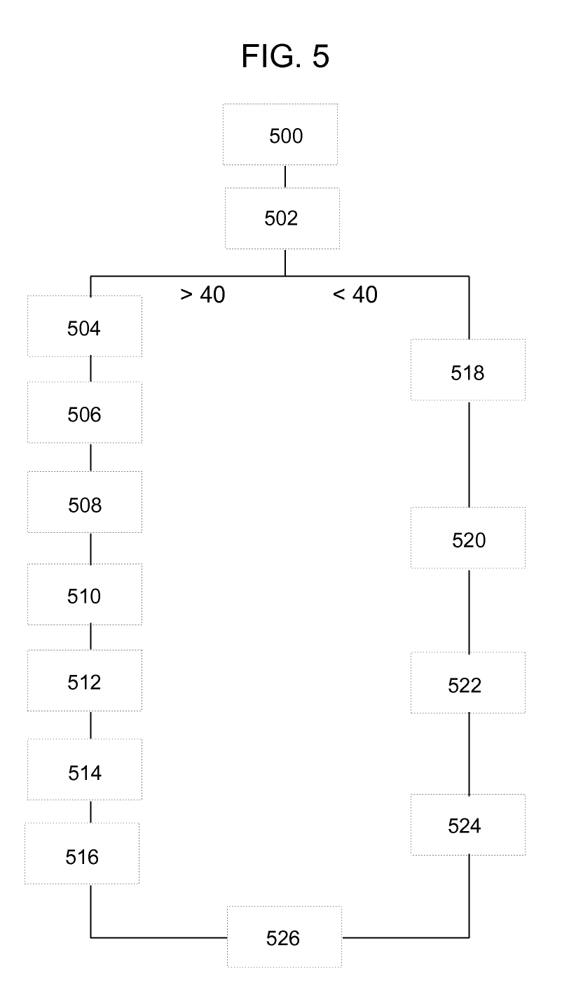

Referring to FIG. 5, shown is a flowchart depicting a process to determine the fee to be charged to a seller using the real estate application. Generally, and in accordance with the preferred embodiment, the process begins by determining the total points for a listing, then proceeds through a segmentation process, then assigns the fee to be charged to the seller for listing the property. Specifically, in step 500, the total points for a listing are counted in accordance with the foregoing principles. In step 502, the segmentation process identifies a geographic area for the subject property and compares the subject property to other properties within the geographic area that are stored for use with the real estate application, referred to as “listed properties”. Specifically, in step 502, the geographic area is identified for the subject property. The geographic area is preferably defined by the neighborhood, school district, zip code, or county in which the property lies, or may be defined by a distance from the property such as a 10 mile radius. It should be understood that any other suitable method may be used to define an appropriate geographic area for the property.

It should be understood that step 502 represents the preferred embodiment, and alternative embodiments may identify listed properties with a characteristic in common with the subject property other than geographic area. Such embodiments may identify listed properties for comparison according to, for example, asking price, type of property, number of bedrooms, number of bathrooms, space size, lot size, local crime rate, school quality rating, architecture, or proximity to a landmark. In one embodiment, the real estate application first identifies the neighborhood of the subject property and determines if there are a sufficient number of other properties available for comparison within the neighborhood. If not, the real estate application identifies the zip code of the subject property and determines if there are a sufficient number of other properties available for comparison within the zip code. If not, the real estate application identifies the city of the subject property and determines if there are a sufficient number of other properties available for comparison within the city. If not, the real estate application identifies the metropolitan statistical area (MSA) for the subject property and proceeds to use the MSA as the geographic area for the subject property. When a city or MSA constitutes the most preferred geographic area for a property, the real estate application accounts for the demographics of the geographic area to ensure there is a sufficient similarity between the neighborhood of the subject property and the other neighborhoods within the geographic area. Exemplary demographics include household income, crime rate, and quality of school districts, although other demographics may be used.

Once the geographic area has been identified in step 502, the number of listed properties within the geographic area is ascertained. If the number of listed properties within the geographic area is at least as high as a desired number, the segmentation process proceeds to step 504. In the preferred embodiment, the desired number of listed properties for comparison is 40. In step 504, the subject property is compared to the listed properties within the geographic area on the basis of property type. Specifically, the subject property is compared to all listed properties within the geographic area, and any listed properties with the same or similar property type are identified. All properties that are the same or similar in property type to the subject property are recorded in a data file as a first subset (“subset 1”). Subset 1 is stored in memory for use with the real estate application. The segmentation process then proceeds to step 506, in which the point total for the subject property is ranked against the point totals for all of the listed properties in subset 1. Preferably, this results in a percentile ranking for the subject property, and the percentile ranking is stored in memory.

The segmentation process then proceeds to step 508, in which the subject property is compared to the listed properties within the geographic area on the basis of the transaction type. Transaction types include, for example, sales, leases, commercial sales, commercial leases, residential sales, residential leases, subleases, short term leases, and long term leases. All properties that are the same or similar in transaction type to the subject property are recorded in a data file as a second subset (“subset 2”). Subset 2 is stored in memory for use with the real estate application. The segmentation process then proceeds to step 510, in which the point total for the subject property is ranked against the point totals for all of the listed properties in subset 2, and the resulting percentile ranking is stored in memory.

The segmentation process then proceeds to step 512, in which the subject property is compared to the listed properties within the geographic area on the basis of one or more property attributes. In the preferred embodiment, the property attributes comprise the number of bedrooms, number of bathrooms, the size of the building, and/or the size of the lot. It should be understood that any suitable attribute may be used to compare the subject property to the listed properties within the geographic area. All properties that are the same or similar to the subject property with respect to property attributes are recorded in a data file as a third subset (“subset 3”). Subset 3 is stored in memory for use with the real estate application. The segmentation process then proceeds to step 514, in which the point total for the subject property is ranked against the point totals for all of the listed properties in subset 3, and the resulting percentile ranking is stored in memory.

The segmentation process then proceeds to step 516, in which the real estate application calculates an overall percentile rank for the subject property. In the preferred embodiment, the real estate application averages the percentile rankings produced in steps 506, 510 and 514 to calculate the overall percentile rank for the subject property. It should be understood that other suitable methods may be used to calculate a rank for the subject property, including for example, weighted averages. It should be apparent that the order of steps 504, 506, 508, 510, 512 and 514 may be reordered without departing from the principles disclosed herein.

It should be understood that in each of steps 504, 508 and 512, as previously described, the subject property is compared to all listed properties within the geographic area. In an alternative embodiment, each of these steps may be used to produce a subset of properties which is used for comparison in the respective following step. In such an embodiment, in step 508, the subject property would be compared to only those properties in subset 1, which would produce a new subset of properties with the same or similar property type as the subject property and the same or similar transaction type as the subject property. This new subset may be referred to as subset 2′. In step 512, the subject property would be compared to the properties in subset 2′ on the basis of property attributes, which would produce a third subset, to be referred to as subset 3′. In such an embodiment, it should be appreciated that the order of operation will continue, such that each step produces a subset that is equal to or smaller than the size of the subset produced by the previous step. In such an embodiment, step 516 is a calculation of the rank of the subject property within subset 3′, and may be expressed as a percentile rank.

Referring back to step 502, if the number of listed properties within the geographic area is below the desired number of 40, the segmentation process proceeds to step 518. In step 518, the average household income (HHI) for the zip code of the subject property is compared to a predetermined table of rankings maintained in memory accessible to the real estate application. The result of the comparison is a percentile ranking for the subject property based on the HHI for the subject property's zip code. The percentile ranking is then stored in memory.

The segmentation process then proceeds to step 520, in which the crime rate for the zip code of the subject property is determined by consulting a lookup table of crime rates organized by zip code. The crime rate of the subject property's zip code is then compared to a predetermined table of rankings maintained in memory accessible to the real estate application. The result of the comparison is a percentile ranking for the subject property based on the crime rate for the subject property's zip code. The percentile ranking is then stored in memory. It should be understood that geographic boundaries other than the zip code and means other than a lookup table could be used to determine the relevant crime rate for the subject property.

The segmentation process then proceeds to step 522, in which the quality rating for the subject property's school district is compared to a predetermined table of rankings maintained in memory accessible to the real estate application. The result of the comparison is a percentile ranking for the subject property based on the quality rating for the subject property's school district. The percentile ranking is then stored in memory. It should be apparent that the order of steps 518, 520 and 522 may be reordered without departing from the principles disclosed herein.

The segmentation process then proceeds to step 524, in which the real estate application calculates an overall percentile rank for the subject property. In the preferred embodiment, the real estate application averages the percentile rankings produced in steps 518, 520 and 522 to calculate the overall percentile rank for the subject property. It should be understood that other suitable methods may be used to calculate a rank for the subject property, including for example, weighted averages.

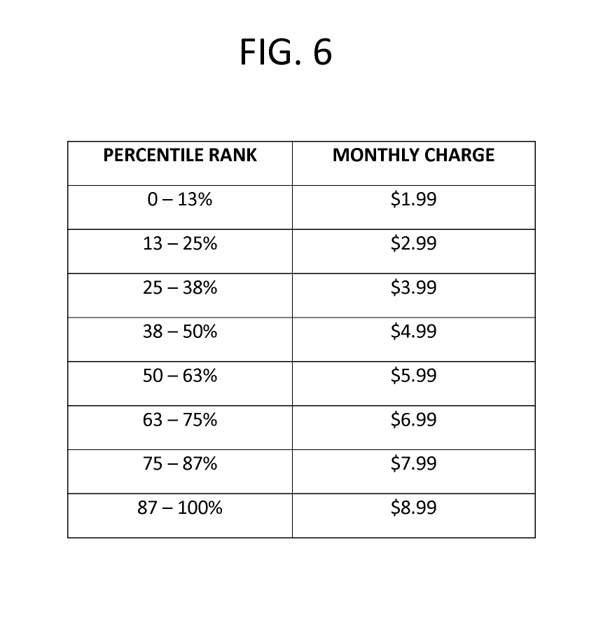

In step 526, the real estate application determines the fee charged to the seller for use of the real estate application. FIG. 6 depicts a table relating overall percentile rank to monthly charge. In the preferred embodiment, a seller of a property with a percentile rank of 0-13% is charged a monthly fee of $1.99, a seller of a property with a percentile rank of 13-25% is charged a monthly fee of $2.99, etc. In the preferred embodiment, the segmentation process is performed on a monthly basis, resulting in a percentile rank for each property stored for use with the real estate application. The percentile rank of each property is then used to determine the monthly fee to be charged to the seller of the property. It should be understood that the foregoing example is not intended to be limiting. The segmentation process may be performed any number of times or on any schedule, and the fees may be determined and charged on any timeframe. If a property is listed for the first time in the middle of a reporting period, for example in the middle of a month, the fees for the seller may be pro-rated or otherwise adjusted.

In the preferred embodiment, the real estate application prepares a report for each listed property on a monthly basis. The report contains the number of points assigned to a property, each interest measure relevant to the property, the amount of time the property has been listed, the percentile rank of the property within each category, and the overall percentile rank for the property. Additional information, such as historic data for the property or metrics regarding all listed properties may be included as well.

In the preferred embodiment, the real estate application also provides recommendations to sellers suggesting improvements to a property listing that could improve its chance of sale. The recommendation algorithms determine the reason(s) one listing receives less interest than its peers, then provide the seller one or more recommendations to improve the listing's performance with respect to its peers.

The recommendation algorithms preferably prioritize recommendations associated with the actions that have the lowest relative interest points for a seller's property. For example, a property that is in the 25th percentile or lower for the number of “multiple picture views” as compared to its peers would elicit a recommendation. If the recommendation algorithms determine that a higher number of photographs, higher quality photographs, or the order of photographs contributes substantially to a listing's performance, the real estate application will provide relevant recommendations to the seller. In the given example, depending the relative deficiencies of the listing, the real estate application may recommend that the seller upload additional photographs, upload higher quality photographs, and/or reorder the existing photographs to highlight particular features of the property to improve the performance of the listing with respect to its peers. It should be understood that comparable recommendations may be made with respect to other features of a property.

In another embodiment, the real estate application comprises an analytics engine that monitors the activities and events affecting the listed properties and discerns trends. The recommendation algorithms then make recommendations to buyers and sellers based on the trends identified by the analytics engine.

In one example, the analytics engine tracks user activities to determine overall consumer demand for properties according to the type of property, the quality of the property, and the condition of the property. More specifically, the analytics engine tracks (1) the number of unique searches for a property type during a period of time, (2) the number of unique users that view a listing's “Detailed View” screen, (3) the number of unique visitors that submit a question or provide feedback, (4) the number of scheduled property visits and the number of attendances at open house events, (5) the number of offers for sale and the terms on which they are made, (6) the number of contracts that are executed and the terms on which they are ratified, (7) contingencies cleared, and (8) the number of properties sold and the associated terms of sale. From these activities, the analytics engine identifies trends and patterns. Trends and patterns may be identified for system-wide use, or for specific geographic areas, for specific time periods, for specific properties sharing a common characteristic, or for any other relevant factor or a combination thereof.

The recommendation algorithms use the information compiled by the analytics engine and the trends and/or patterns identified by the analytics engine to provide data and make recommendations to buyers and sellers to improve the likelihood of completing a transaction and to increase the value of the transaction for the user. For example, the recommendation algorithms provide information to a seller regarding the current and past supply of properties similar to the one being listed by the seller. The recommendation algorithms also provide information to a seller regarding the current demand for properties similar to the one being listed by the seller. The recommendation algorithms also provide information to the seller regarding the mean, median and standard deviation of time from listing properties similar to the one listed by the seller to the time of sale, time of contract ratification, time of first offer, and other relevant times in the transaction process. The recommendation algorithms also provide information to a seller regarding the number of offers made for properties similar to the one being listed by the seller before a contract ratification or sale. The recommendation algorithms also provide information to a seller regarding the pricing and length of time to close for homes similar to the seller's property. The recommendation algorithms also provide information to a seller regarding the number of visitors to expect on a weekly or monthly basis based on data for properties similar to the one listed by the seller. The recommendation algorithms also provide information to a seller regarding the number of inquiries from prospective buyers to expect for a period of time based on data for properties similar to the one listed by the seller. Using trends and/or patterns identified by the analytics engine, the recommendation algorithms also provide recommendations to a seller regarding what timeframes are more or less likely to attract interested prospective purchasers. Using the information compiled by the analytics engine and the trends and/or patterns identified by the analytics engine, the recommendation algorithms provide a seller with information regarding the expected terms of offers made for the seller's property, as well as an expected sale price and the likelihood of closing based on specific offer terms. The recommendation algorithms also provide the seller with an estimate regarding the length of time to close for the seller's property. The recommendation algorithms further provide information regarding the effects of school quality, crime rate, HHI, and other factors on the expected length of time to sell the seller's property and the length of time to sell similar properties. It should be understood that recommendations and information provided to the seller are not limited to the foregoing examples. In some embodiments, recommendations and information may be made on a real-time basis, may be delayed, may relate to specific time periods, or may be future-looking or predictive.

In a specific example, the recommendation algorithms may advise a particular seller that there is a large supply of similar properties within the seller's zip code, that demand for properties similar to the one listed by the seller is moderate, that similar properties are on average listed for two months before receiving an offer, that on average 1.5 offers are received before a contract is ratified, that the seller should anticipate approximately two visitors per week to view the property, that similar properties have sold most quickly in the months of April and August, that open houses are most effective when held on a Sunday, and that the seller should expect offers that are 10-15% lower than the listed asking price. In another example, the recommendation algorithms may advise a seller that because of a higher volume of similar properties in the nearby area, the seller should wait to list the property in order to improve the chances of selling at the desired price. In yet another example, the recommendation algorithms may recommend that a seller improve one or more features of the property, such as by installing new cabinets and countertops in the kitchen, in order to improve the property's attractiveness relative to nearby properties and thereby improve the chances of selling at the desired price.

In an alternative embodiment, the foregoing principles may be used in a real estate application to advertise a buyer's interests. In such an embodiment, a buyer accesses the system and enters the buyer's preferred criteria for a property, such as the zip code, the number of bathrooms and the size of the lot. The real estate application then creates a listing on behalf of the buyer, which may be searched by prospective sellers. The real estate application monitors interest measures for the buyer's listing, performs a segmentation process to determine which listings are similar, and then ranks the similar listings, determines an overall percentile ranking of the buyer's listing, and determines the monthly fee the buyer must pay for use of the real estate application.

Users of the real estate application may be given free access to the application and the services it provides. In the preferred embodiment, the seller is charged a fee based on the percentile rank of the listing according to the table depicted in FIG. 6. In other embodiments, a seller is not charged a fee based on the percentile rank or number of interest points generated by the listing. The seller may be charged for recommendations provided by the recommendation algorithms. The seller may be charged for reporting and analysis generated by the analytics engine. Fees may be incurred on the basis of the number of recommendations, the number of reports, the volume of data, on a subscription basis, or according to any other suitable fee arrangement.

While the present invention has been described with reference to the preferred embodiment, which has been set forth in considerable detail for the purposes of making a complete disclosure of the invention, the preferred embodiment is merely exemplary and is not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A computer system for communicating information over a network, comprising:
a memory; and
a processor that:
stores information comprising property data in the memory;
creates a listing comprising the information and stores the listing in the memory;
receives, via a network, a search request from a user comprising search criteria;
provides, via the network, the listing to the user;
receives, via the network, a subsequent request from the user;
records the subsequent request in the memory;
records a point value in the memory in response to the subsequent request;
compares the point value to one or more previously stored point values for one or more listings stored in the memory to calculate a rank;
using the rank, calculates a fee for the listing; and
stores the fee in the memory.

2. The computer system of claim 1, wherein the information further comprises one or more images.

3. The computer system of claim 1, wherein the information is received from a second user via the network.

4. The computer system of claim 1, wherein the point value is determined using a lookup table.

5. The computer system of claim 1, wherein the fee is calculated using a lookup table.

6. The computer system of claim 1, wherein the subsequent request comprises a request for more information, a request to view images, a request for a virtual tour, a request to view an open house schedule, a request to schedule an appointment, a request to submit correspondence, a request to view a property history, a request to store the listing, a request to tour a property, or a request to submit an offer.

7. The computer system of claim 1, wherein the processor identifies one or more listings stored in the memory that share one or more common characteristics with the property data.

8. The computer system of claim 7, wherein the one or more common characteristics comprises one or more of: geography, property type, transaction type, property attribute, school district, and characteristics of the property's zip code.

9. A method of electronically operating an advertising service, comprising:
storing information comprising property data in the memory;
forming a listing comprising the information and storing the listing in the memory;
receiving a search request from a user comprising search criteria;
providing to the user the listing;
receiving a subsequent request from the user;
recording the subsequent request in the memory;
recording a point value in the memory in response to the subsequent request;
comparing the point value to one or more previously stored point values for one or more listings stored in the memory to calculate a rank;
using the rank, calculating a fee for the listing and storing the fee in the memory.

10. The method of claim 9, wherein the information further comprises one or more images.

11. The method of claim 9, wherein the information is received from a second user via the network.

12. The method of claim 9, wherein the point value is determined using a lookup table.

13. The method of claim 9, wherein the fee is calculated using a lookup table.

14. The method of claim 9, wherein the subsequent request comprises a request for more information, a request to view images, a request for a virtual tour, a request to view an open house schedule, a request to schedule an appointment, a request to submit correspondence, a request to view a property history, a request to store the listing, a request to tour a property, or a request to submit an offer.

15. The method of claim 9, wherein the processor identifies one or more listings stored in the memory that share one or more common characteristics with the property data.

16. The method of claim 15, wherein the one or more common characteristics comprises one or more of: geography, property type, transaction type, property attribute, school district, and characteristics of the property's zip code.
